(19) United States
(12) Patent Application Publication
(10) Pub. No.: US 2021/0335561 A1
(43) Pub. Date: Oct. 28, 2021

(54) LIGHTING CONTROL CONSOLE HAVING A ROTARY CONTROL

(71) Applicant: MA LIGHTING TECHNOLOGY GMBH, Waldbüttelbrunn (DE)

(72) Inventor: Michael Adenau, Würzburg (DE)

(21) Appl. No.: 16/318,869

(22) PCT Filed: Nov. 9, 2017
(86) PCT No.: PCT/EP2017/078711

§ 371 Date: Jan. 18, 2019

(51) Int. Cl. H01H 19/02; F21V 23/00

(52) U.S. Cl. CPC H01H 19/025; F21Y 2115/10; F21V 23/003

(57) ABSTRACT

The invention concerns a lighting control console (01) for controlling a lighting system, digital adjusting commands being generated in the lighting control console (01), said adjusting commands being able to be transmitted to the lighting devices of the lighting system via data links, and said lighting control console (01) comprising at least one digital processor and at least one digital memory for generating, managing and storing the adjusting commands, and said lighting control console (01) comprising at least one display device (02, 03), and graphic elements being able to be graphically depicted for users at the display device (02, 03), and at least one rotary control (5) being provided in the control panel of the lighting control console (01), input values being able to be input by the user by adjusting an illuminable rotary knob (7) in a rotatory manner, at least one light source for illuminating the rotary knob (07) being provided in the housing (13) of the lighting control console (01), a light conducting element comprising at least one light entry surface and at least one light exit surface being provided in said rotary knob (07), and the light of the light source being able to be coupled into the light conducting element at the light entry surface, and the light being able to exit from the light conducting element at the light exit surface so as to illuminate the rotary knob (7) from the inside.

The invention relates to a lighting control console having a rotary control according to the preamble of claim 1.

Generic lighting control consoles serve for controlling lighting systems such as they are used in theaters or for concert stages. These lighting systems generally comprise a plurality of lighting devices, such as stage spotlights, wherein, in the lighting devices on their own, it is in many cases also possible to switch between a plurality of lighting conditions, for instance between different colors. These different lighting conditions are controlled via programmed parameters in the lighting program of the lighting control console. Common lighting systems can comprise up to several thousand lighting devices.

To be able to control such complex lighting systems, the generic lighting control consoles are equipped with a digital processor which allows digitally processing data and signals. In addition, a digital memory is provided for storing the data, which in particular allows archiving lighting programs.

In order to program the lighting program or for controlling the lighting program during a sequence, the user has to input control commands as input values. In this context, this can be the selection of a certain lighting device or the setting of a certain lighting parameter, such as luminosity. Mechanical control elements, such as pushbuttons, slide controls or rotary controls, are provided for inputting these control commands at known lighting control consoles. The control commands allocated to the individual control elements can be altered via suitable menu switches in order to be able to program and control accordingly complex lighting programs.

The rotary controls installed in the known lighting control consoles are characterized by the inputs being carried out by adjusting a control knob in a rotatory manner. For this purpose, the control knob is disposed outside of the housing of the lighting control console and is held in place by a console installed in the housing.

Lighting control consoles are often used in a setting which is to be kept dark, such as a theater or concert hall. Extraneous light for illuminating the control panel on the lighting control console is unwelcome in such settings which are to be darkened. In order to still enable the user to safely access different control elements, lighting control consoles are known in which the control elements are illuminated by small lights from the outside. This illumination from the outside, however, is of little value in particular for rotary controls, as rotary controls are comparatively small and a plurality of rotary controls would have to be distinguished from one another.

The object of the present invention is therefore to propose a lighting control console having rotary controls where the rotary controls can be distinguished from one another more easily while requiring the least possible amount of constructional expenditure.

This object is attained by a lighting control console according to the teachings of claim 1.

Advantageous embodiments of the invention are the subject matter of the dependent claims.

The lighting control console according to the present invention is characterized by rotary controls which can be backlit from the inside. For this purpose, a light source for illuminating the rotary knob is provided in the housing of the lighting control console. The rotary knob itself comprises a light conducting element having a light entry surface and at least one light exit surface. During operation of the lighting control console, the light from the light source is coupled into the light conducting element at the light entry surface and exits from the light conducting element at the light exit surface from the inside in order to thus illuminate the rotary knob from the inside. As rotary controls of lighting control consoles are designed to have relatively small dimensions, it is very time-consuming and costly to attach a separate light conducting element inside the rotary knob of the rotary control. Therefore, it is particularly advantageous and cost-effective for the rotary knob itself to be designed as a light conducting element so as to be illuminated in its entirety in this manner.

A light conducting rotary knob such as described above is particularly easy and cost-effective to produce when being made of a plastic material capable of conducting light.

Making the entire rotary knob from a plastic material capable of conducting light can lead to the rotary knob being illuminated from the inside with a relatively high degree of luminosity, which, however, is undesirable as this can lead to an unwanted blinding effect for the user. In order to avoid this and still be able to use rotary knobs made of a plastic material capable of conducting light, it is particularly advantageous to attach a cover cap to the protruding part of the rotary knob. This cover cap covers the light exit surface of the rotary knob at least partially. In order to nevertheless achieve the desired illumination effect for marking the rotary knob, the cover cap comprises at least one light transit surface which allows light exiting from the rotary knob to pass through the cover cap so as to create the respective optical marking of the rotary control.

The constructional design of the cover cap is essentially arbitrary. For a cylindrical rotary knob, it is particularly advantageous if the first end face of the cylindrical rotary knob, which is usually plugged in the console of the rotary control, is designed as a light entry surface. In this manner, a lighting element installed in the console of the rotary control is able to illuminate the first end face of the rotary knob serving as a to light entry surface. The second end face of the shell surface of the cylindrical rotary knob can then serve as the light exit surface and can provide for a correspondingly bright illumination.

According to a preferred embodiment, the cover cap for covering the rotary knob illuminated from the inside is cylindrical as well and is produced with an open end face. Said open end face serves for attaching the cover cap to the cylindrical rotary knob. The shell surface of the cylindrical cover cap is preferably designed to be opaque. Merely the closed end face pointing to the top presents a translucent light transit surface so that after the installation of the cover cap on the illuminated rotary knob only the upper end face of the rotary control is illuminated.

In order to allow the user to flexibly adjust the luminosity for the rotary controls depending on the respective situation of usage, in particular with regard to the darkening, it is particularly advantageous for the cover cap to be attached to the rotary knob in a removable manner so that the user can either increase or decrease the luminosity by attaching or removing the cover cap.

A preferred light source for backlighting the rotary knob are LED illumination means as said LED illumination means only lead to minimal heat loss and therefore excessive heating of the rotary knob can be avoided.

An embodiment of the invention is schematically illustrated in the drawings and is explained by means of examples hereinafter.

In the following,

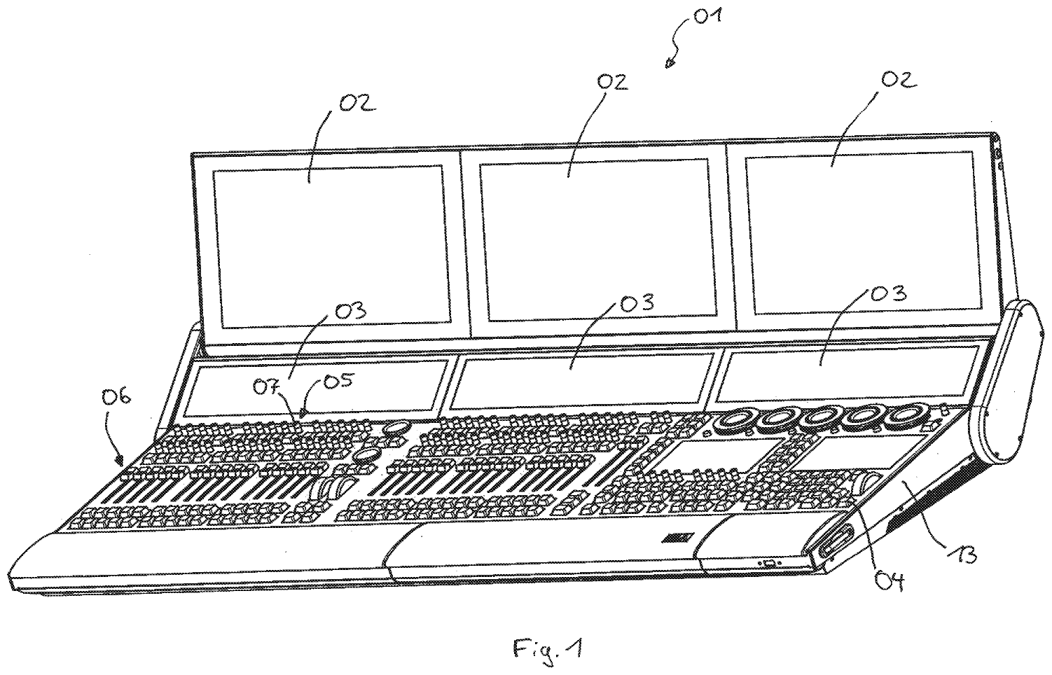

FIG. 1 illustrates a lighting control console having several rotary controls in a perspective view from the front;

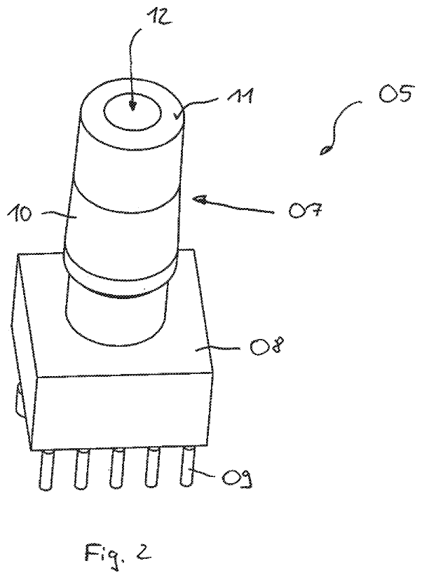

FIG. 2 illustrates a rotary control of the lighting control console according to FIG. 1 dismounted from the console in a perspective view from the front;

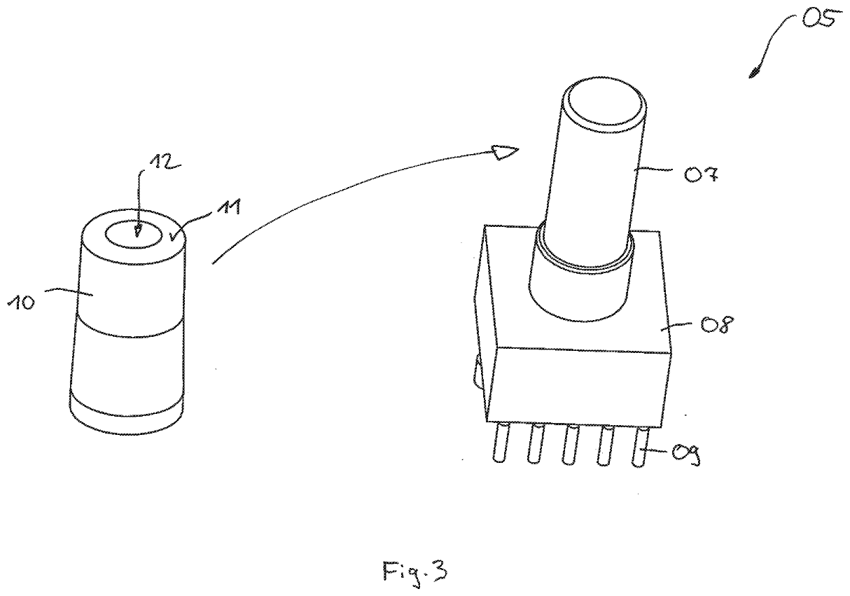

FIG. 3 illustrates the rotary control according to FIG. 2 having its cover cap removed in a perspective view from the front.

FIG. 1 illustrates in a perspective view a lighting control console 01 according to the invention for programming and controlling a stage lighting system. The lighting control console 01 is equipped with three monitors 02 and three monitors 03 for displaying various menus to the user. For inputting adjusting commands, a plurality of pushbuttons 04, rotary controls 05 and slide controls 06 are provided at the lighting control console 01. The rotary knobs 07 (see FIG. 2) of the rotary controls 05 protrude from the housing 13 of the lighting control console 01 so that the user can apply appropriate rotary movements to the rotary knob.

FIG. 2 shows the rotary control 05 in a perspective view from the front. The rotary knob 07 is mounted on a console 08 in a rotatable manner. A potentiometer can be disposed in the console 08, said potentiometer converting the rotatory control commands at the rotary knob 07 into the respective electrical signals. This information can be transferred via electrical contacts 09 to the actual mainboard of the lighting control console.

Furthermore, an LED lighting unit for illuminating the rotary knob 07 is installed in the console 08. For this purpose, the light generated by the LED light source is coupled in at the end face of the rotary knob 07 integrated in the console 08. The rotary knob 07 itself is made of a plastic material capable of conducting light and thus serves as a light conducting element.

A cylindrical cover cap 10 is attached to the cylindrical rotary knob 07, the shell surface of said cover cap 10 being made of an opaque plastic material. The light exiting from the rotary knob 07 is strongly reduced due to the attachment of the cover cap 10. The cover cap 10 comprises a to light transit surface 12 only on its end face 11 pointing to the top. As a result, only the light transit surface 12 is illuminated during illumination of the rotary knob 07 so that blinding effects resulting from bright light development on the rotary controls 05 can be precluded.

1. A lighting control console for controlling a lighting system, digital adjusting commands being generated in the lighting control console, said adjusting commands being able to be transmitted to the lighting devices of the lighting system via data links, and said lighting control console comprising at least one digital processor and at least one digital memory for generating, managing and storing the adjusting commands, and said lighting control console comprising at least one display device, and graphic elements being able to be graphically depicted for users at the display device, and at least one rotary control being provided in the control panel of the lighting control console, input values being able to be input by the user by adjusting an illuminable rotary knob in a rotatory manner,
wherein
at least one light source for illuminating the rotary knob is provided in the housing of the lighting control console, a light conducting element comprising at least one light entry surface and at least one light exit surface being provided in said rotary knob, and the light of the light source being able to be coupled into the light conducting element at the light entry surface, and the light being able to exit from the light conducting element at the light exit surface so as to illuminate the rotary knob from the inside.

2. The lighting control console according to claim 1, wherein
the rotary knob in its entirety is realized in the manner of a light conducting element.

3. The lighting control console according to claim 2, wherein
the rotary knob is made of a plastic material capable of conducting light.

4. The lighting control console according to claim 1,
wherein
a cover cap is attached to the part of the rotary knob protruding from the housing of the lighting control console, said cover cap partially covering the light exit surface of the rotary knob, said cover cap comprising at least one light transit surface at which the light exiting at the rotary knob is allowed to pass through.

5. The lighting control console according to claim 1,
wherein
the rotary knob has a cylindrical shape, the first end face of the cylindrical rotary knob being designed as the light entry surface, and the second end face and the shell surface of the cylindrical rotary knob being designed as the light exit surfaces.

6. The lighting control console according to claim 4, wherein
the cover cap has a cylindrical shape having an open end face, the shell surface of the cylindrical cover cap being opaque, and the end face of the cylindrical cover cap comprising a translucent light transit surface.

7. The lighting control console according to claim 4,
wherein
the cover cap is attached to the rotary knob in a removable manner.

8. The lighting control console according to claim 1,
wherein
the light source is realized in the manner of a light emitting diode (LEN).
